(19) United States
(12) Patent Application Publication
(10) Pub. No.: US 2011/0298721 A1
(43) Pub. Date: Dec. 8, 2011

(54) Touchscreen Interfacing Input Accessory System and Method

(76) Inventor: Martin Eldridge, San Diego, CA (US)

(21) Appl. No.: 12/792,165

(22) Filed: Jun. 2, 2010

(51) Int. Cl. G06F 3/041

(52) U.S. Cl. 345/173

(57) ABSTRACT

A Touchscreen Interfacing Input Accessory System and Method is disclosed. The accessory device is attachable to the screen of a touchscreen monitor. The accessory device creates an input/output port that uses the touchscreen for I/O interface to the computing device. User input devices are attachable to an interface module that is attached to the touchscreen display by a suction cup or other mechanism. The input devices include user-operable mechanical knobs, controls, and virtually any other input device. The interface module aligns with input/output regions identified on the touchscreen so that the module can send data through the screen via simulated touches, and receive data from through the screen via visual data displayed by the monitor.

### BACKGROUND OF THE INVENTION

1. Field of the Invention

This invention relates generally to computing devices and systems and related thereto and, more specifically, to a Touchscreen Interfacing Input Accessory System and Method.

2. Description of Related Art

Advancements in computers and related devices seemingly never end; an exemplary assembly of a conventional computing device and potential peripherals is depicted in FIG. 1. One of the latest products that has now become fairly mainstream is the touchscreen display device 10. A touchscreen is an electronic visual output that can detect the presence and location of a touch within the display area. The term touchscreen generally refers to touch or contact to the display of the device by a finger or hand. Touchscreens can also sense other passive objects, such as a pen or stylus. The ability to interact physically with what is shown on a display (a form of “direct manipulation”) typically indicates the presence of a touchscreen. The touchscreen display device 10 comprises a housing 12 within which is contained a touch-sensitive display screen 14. The idea behind the touchscreen display device 10 is that not only can the computing device 20 display information as with the prior types of monitors (i.e. standard, non-touchscreen), but also it allows the user to provide input to the computing device 20 by touching the display screen 14. In order to communicate with the computing device 20, the device 10 will have an input conduit or cable 18 for display of data from the computing device 20, an output conduit 16 which transfers input data information from the display device 10 to the computing device 20.

It should be understood that when we describe the input and output conduit 16 and 18 respectively, typically we are talking about cables; however, wireless connections of a variety of types are also available. Furthermore, here the computing device 20 and touchscreen 10 are shown as separate assemblies but, in fact, it is very common for portable or laptop computers to be the most prevalent that are equipped with a touchscreen display device 10 built in. In addition to the display device 10, there is usually a variety of different permanent and temporary peripheral devices. These can be generally described as input devices 22, output devices 24 and other peripheral devices 26.

A few examples of input devices 22 include a pointing device or mouse 28, a keyboard 30 and a game controller 32. A very common output device 24 is a printer 34. Three examples of peripheral devices 26 include a camera 36 of the digital variety, a music player 38 and an optical scanner 40. In most cases, even if a computing device is equipped with a touchscreen display device 10, it still will be necessary for the computing device 20 to also access additional input, output and peripheral devices. If we now turn to FIG. 2, we can examine how a typical touchscreen display device is used as a combination input and output device.

FIGS. 2A and 2B are cutaway side and partial front views of a conventional touchscreen display device. In FIG. 2A, we see that the display device 10, and in particular the display screen 14, is actually a pair of separate subassemblies. There is the display screen assembly 44 immediately adjacent to which is an input screen assembly 42. As discussed below, there are a variety of different technologies, but in general the input screen assembly 42 is transparent and is closely coupled to the display screen assembly 44 so that it can detect either physical displacement (such as from a finger touch) or an electrical current change that are interpreted to be a command from the touch of a user's finger and/or a pointing device such as a stylus. A resistive touchscreen panel is composed of several layers, the most important of which are two thin, metallic, electrically conductive layers separated by a narrow gap. When an object, such as a finger, presses down on a point on the panel's outer surface the two metallic layers become connected at that point: the panel then behaves as a pair of voltage dividers with connected outputs. This causes a change in the electrical current which is registered as a touch event and sent to the controller for processing.

A capacitive touchscreen panel consists of an insulator such as glass, coated with a transparent conductor such as indium tin oxide (ITO). As the human body is also a conductor, touching the surface of the screen results in a distortion of the body's electrostatic field, measurable as a change in capacitance. Different technologies may be used to determine the location of the touch. The location can be passed to a computer running a software application which will calculate how the user's touch relates to the computer software).¹ ¹ see Wikipedia “Touchscreen”

FIG. 2B shows representative screen displays on the touch-sensitive display screen 14 of how the touchscreen device 10 can be used as an input device. In the upper left-hand corner, a touch-actuated dial 46 has been generated for the user's operation. It should be understood that the display of the dial 46 is actually a computer-generated depiction on the display screen assembly 44. Here there is a knob image 48 with a sort of rotation disc image 50 overlaid atop it. As can be imagined, the user simply touches and then drags his or her finger to the rotation disc image 50 within the confines of the knob image 48. A dial 46 such as this would be convenient for use as a volume control or to increase brightness or to replace a mechanical rheostat or other similar device.

Also depicted in this FIG. 2B is a touch-actuated slide volume control 52. Here the user need simply touch his or her finger on the slider disc image 56 and then drag it right or left along the slide bar image 54 in order to increase or decrease the volume presumably emanating from the speakers or headphones.

There are many, many other computer-generated input devices that are possible when using a touchscreen display device 10. The problem is that many times these one-dimensional “tools” tend to be actually less functional than a mechanical device. So while the user benefits from endless flexibility in the features and functionality for onscreen control elements, the user also loses the ability to feel the control of the variety of elements as that user would if they were turning an actual knob or pushing an actual slider in the three-dimensional sense. Consequently, it is common that the user needs to watch him or herself operating the screen representation of the control element while making adjustments because otherwise it would be easy to simply drag the finger or stylus off the edge of the image thereby losing control.

What is needed is a device and method that is as flexible and convenient as an onscreen input device for touchscreens, but also provides the user with a three-dimensional, tactile element to feel while the control is happening.

### SUMMARY OF THE INVENTION

In light of the aforementioned problems associated with the prior devices, systems and methods, it is an object of the present invention to provide a Touchscreen Interfacing Input Accessory System and Method. The accessory device should be attachable to the screen of a touchscreen monitor. The accessory device should create an input/output port that uses the touchscreen for I/O interface to the computing device. User input devices should be attachable to an interface module that is attached to the touchscreen display by a suction cup or other mechanism. The input devices should include user-operable mechanical knobs, controls, and virtually any other input device. The interface module should align with input/output regions identified on the touchscreen so that the module can send data through the screen via simulated touches, and receive data from through the screen via visual data displayed by the monitor.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 depicts an exemplary assembly of a computing device and potential peripherals;

FIGS. 2A and 2B are cutaway side and partial front views of a conventional touchscreen display device;

FIGS. 3A and 3B are top and bottom partial perspective views of a preferred embodiment of the touchscreen-interfacing input accessory of the present invention;

FIG. 4 is a perspective view of a first embodiment of the device of FIGS. 3A and 3B;

FIG. 5 is an exploded perspective view of a second embodiment of the device of FIGS. 3A, 3B and 4;

FIG. 6 depicts a chain of devices of FIGS. 3A, 3B, 4 and 5;

FIG. 7 depicts the physical cooperation of the device of the present invention and a conventional touchscreen display device;

FIG. 8 depicts a preferred embodiment of the user input communications process of the present invention; and

FIG. 9 depicts a preferred embodiment of the computing device output communications process of the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Touchscreen Interfacing Input Accessory System and Method.

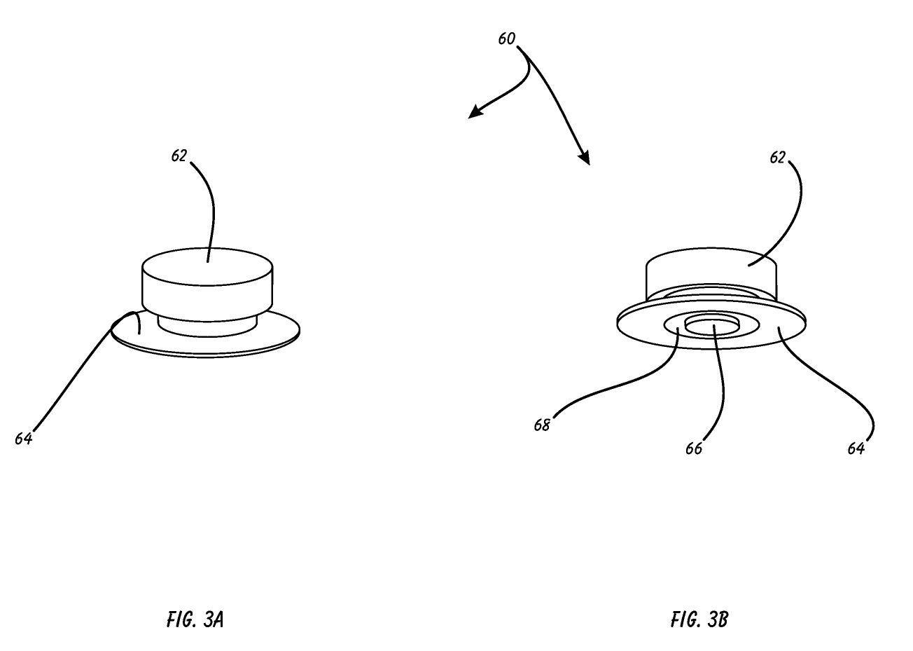

The present invention can best be understood by initial consideration of FIGS. 3A and 3B. FIGS. 3A and 3B are top and bottom partial perspective views of a preferred embodiment of the touchscreen-interfacing input accessory 60 of the present invention.

The touchscreen interfacing input accessory 60 is designed to provide the computer user with the flexibility of an onscreen input control element but also the comfort and control of a three-dimensional physical mechanical control element. It provides this by creating an interface that allows input and output through the screen of a touchscreen display that expands greatly upon simple sensation or detection of physical location of user touches on the touchscreen and display.

A key element to this functionality is the interface module 62. The interface module 62 has an attachment element 64 extending downwardly from it. In this version the attachment element 64 is very similar to a conventional suction cup. It should be apparent the attachment element 64 is designed to allow the interface module 62 to be securely yet temporarily attached to the display screen of a touchscreen display. Here, a suction cup is employed, however, other versions may be used. For example, static cling plastic elements (similar to window decals) could be used. Furthermore, one of a variety of adhesives (typically of the temporary variety) could also be used.

As shown in FIG. 3B, the interface module 62 has an input transmitter 66 and an output detector 68. Although shown here as circular with the output detector 68 encompassing the input transmitter 66, it should be understood that other options are available including an interface module 62 having a plurality of input transmitters 66 and a plurality of output detectors 68 in virtually any combinations thereof. If we now turn to FIG. 4, we can see a first example of a control element of the present invention.

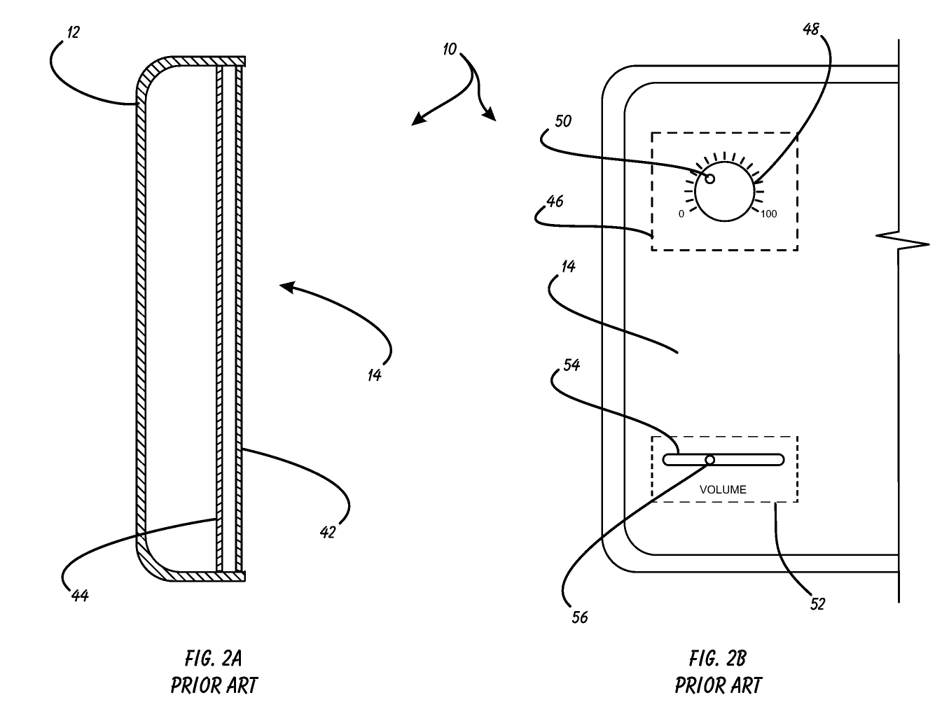

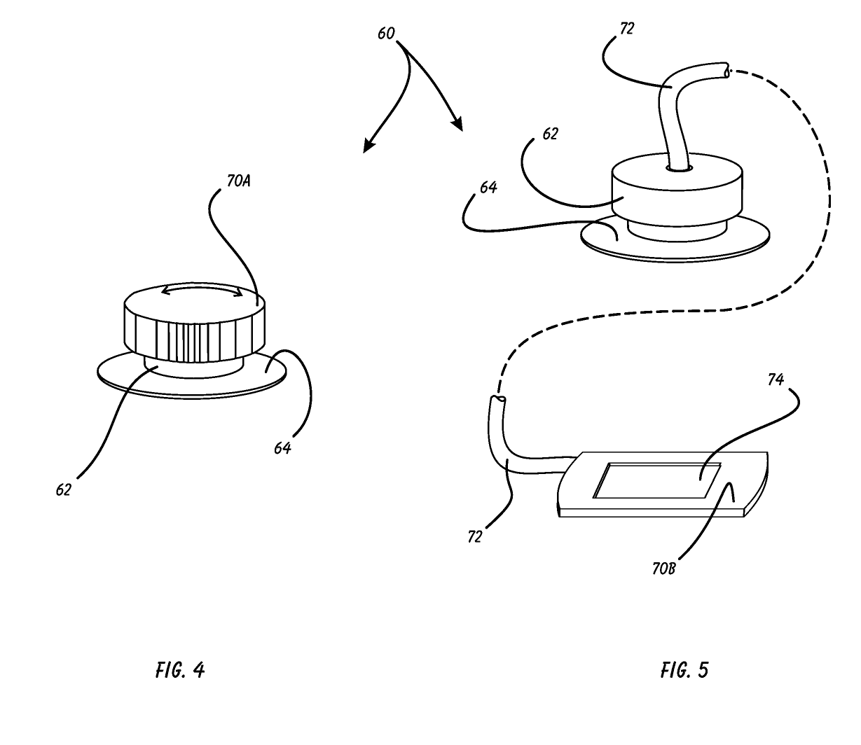

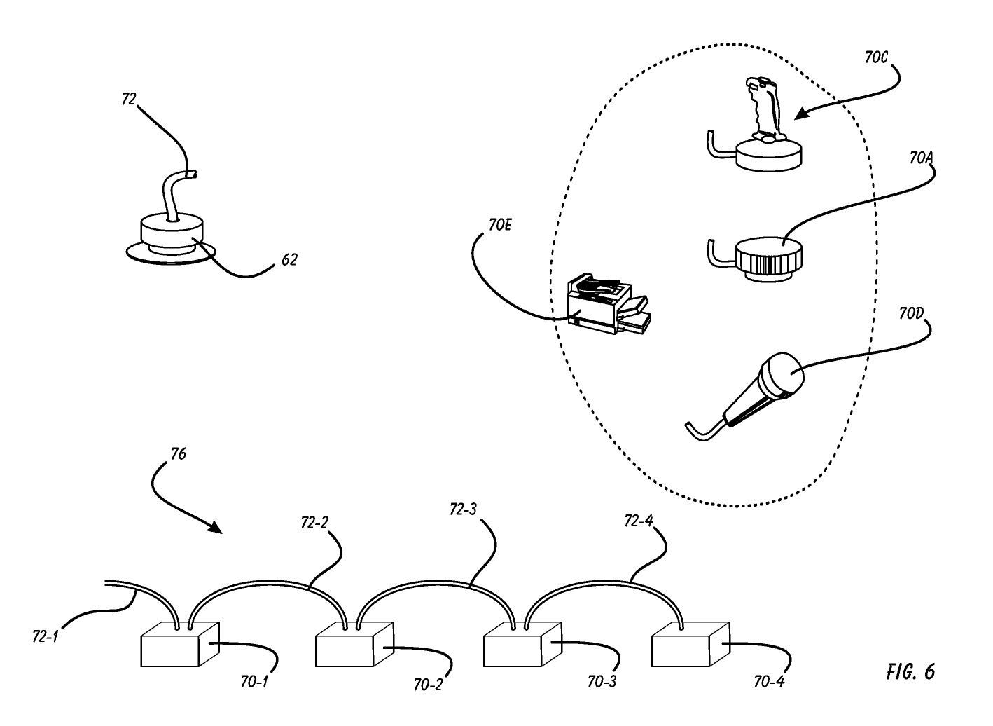

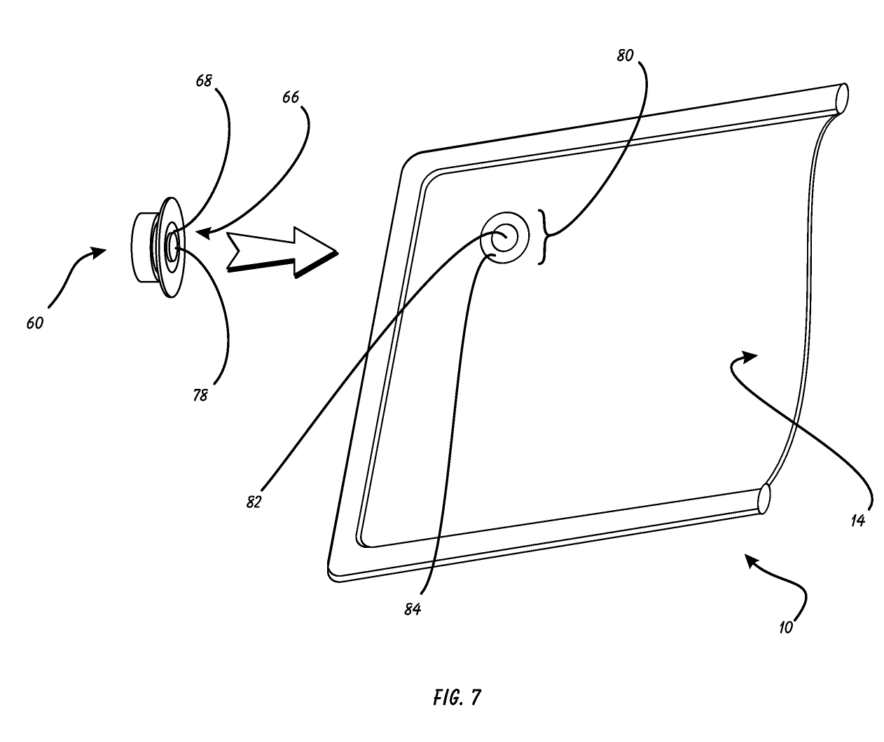

FIG. 4 is a perspective view of a first embodiment of the device of FIGS. 3A and 3B. Here a knob input control element 70A is associated with the interface module 62. This permits the user to have a three-dimensional mechanical element that be or she can grasp in order to provide the same user input as discussed above in FIG. 2 regarding the touch-actuated dial. By rotating the knob input control element 70A, the user can increase or decrease whatever parameter has been assigned to be operated by this input accessory 60. As shown here, the attachment element 64 would hold the assembly to the touchscreen display thereby giving the user a handy input and control element. FIG. 5 depicts another option for a touchscreen interfacing input accessory 60.

FIG. 5 is an exploded perspective view of a second embodiment of the device of FIGS. 3A, 3B and 4. Here a fingerprint scanner device 70B is actually separated from the interface module 62. They are connected by a communications cable 72 which allows the interface module 62 to be attached to the touchscreen display while this fingerprint scanner device 70B would typically be placed on a desktop or other surface in spaced relation to the touchscreen display such as fingerprint scanner device 70B would tend to have a scanner pad 74 whereat the user would swipe his or her finger in order to provide input to the computing device typically for the purposes of security or identification. It should be apparent from these FIGS. 4 and 5 the input accessory 60 could be a software control input device or further could be virtually any type of input. As shown in FIG. 6, it could become apparent that not only input devices but also output and other peripheral devices could use the system and the device and method of the present invention.

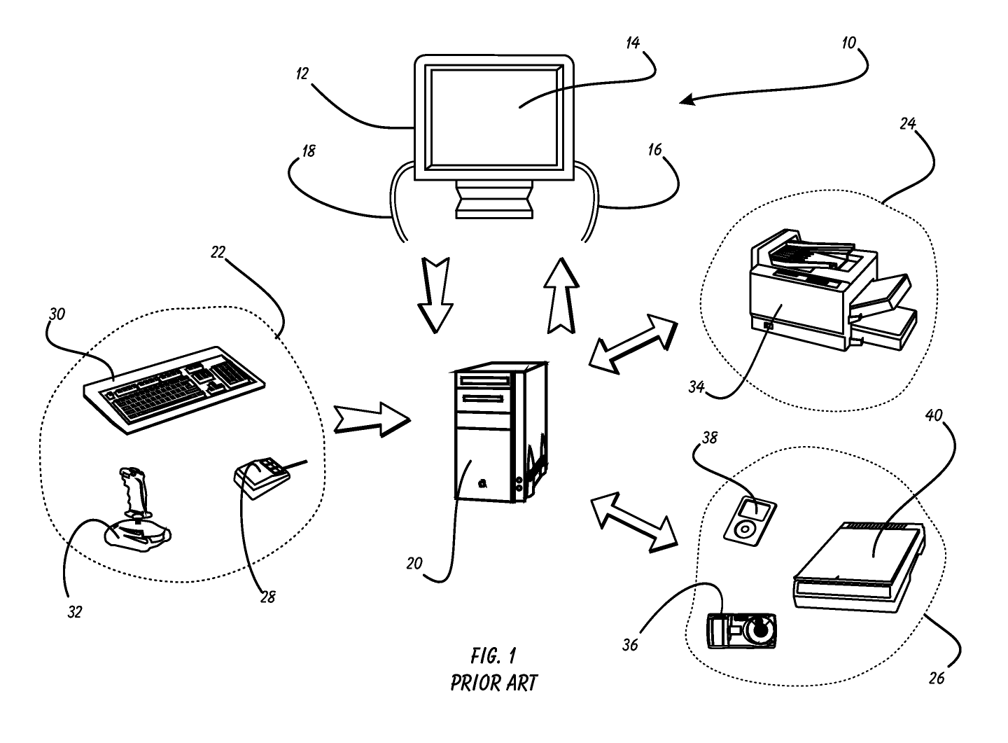

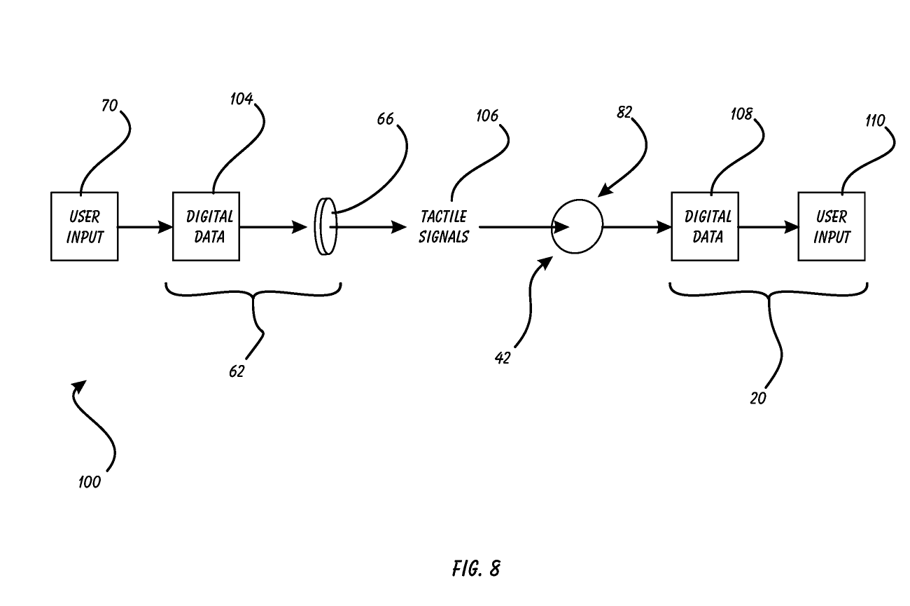

FIG. 6 depicts a chain of devices of FIGS. 3A, 3B, 4 and 5. As shown in FIG. 6, the group of input/output devices 70 that could be connected to the interface module 62 either by communications cable 72 or by being an integrated part of the same housing as the interface module 62 or could be a joystick control device 70C, the knob input control device 70A as previously discussed or could even be a sound input data device 70D such as a microphone. Furthermore, printers, cameras, scanners, virtually all of the group of input/output or peripheral devices discussed above in connection with FIG. 1 could be affiliated with the interface module 62 of the present invention in order to provide the user with either output or input or peripheral control just as with the prior setup. In fact, as shown in the bottom half of FIG. 6, a plurality of these input/output devices 70 could be interlinked to create a device chain 76. There could be a plurality of devices interconnected by a plurality of communications cable to a single interface module 62. Alternatively, there could be individual interface module 62 attached at separate locations around the face of the touchscreen display with each interface module 62 linking to one or more different input/output devices 70. Now turning to FIG. 7, we'll examine how such a system would work.

FIG. 7 depicts the physical cooperation of the device of the present invention and a conventional touchscreen display device. As shown here, the touchscreen interfacing input accessory 60 attaches by suction cup or other attachment means to the touch-sensitive screen 14. There would be an interface region 80 identified on the touch-sensitive screen 14. This region 80 would include a data receiver region 82 and a data transmitter region 84. These regions 82 and 84 would be configured to cooperate with the accessories 60 so that they align with the face 78 of the input transmitter 66 and the output detector 68. It is expected that the control software running on the computing device that is designed to interface with the accessory 60 would include functionality that locates and registers the interface region 80 wherever the user wishes in a very similar fashion to when a user first initializes a touchscreen device and the user must calibrate that device by touching a plurality of sequential predetermined points on the screen.

In the case of the present invention, the system will allow the user to place the accessory 60 wherever he or she wishes on the touch-sensitive screen 14 after which the interface region 80 would be identified so that the output detector 68 is aligned with the data transmitter region 84 and the input transmitter 66 is aligned with the data receiver region 82.

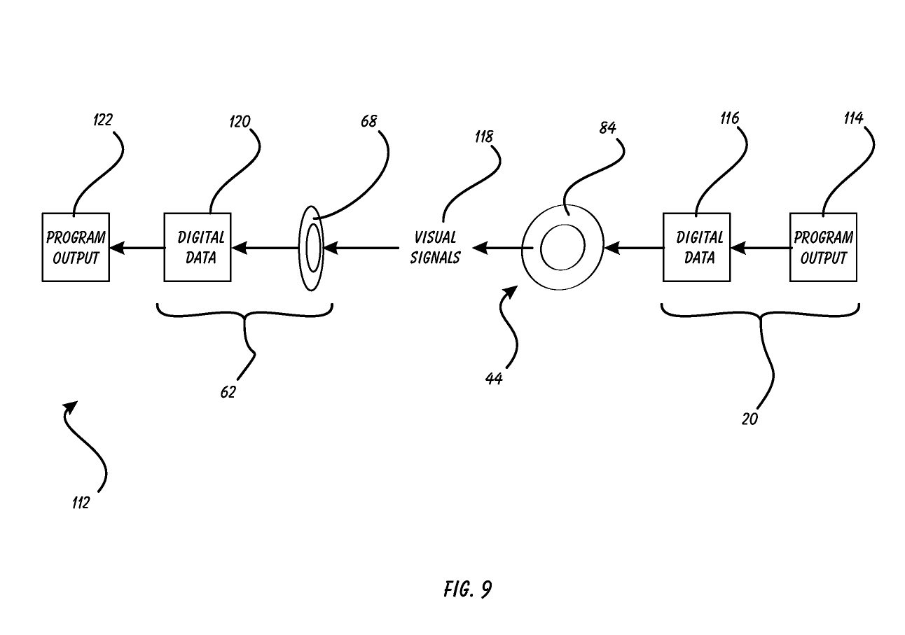

Once attached, the accessory 60 will receive its input from the touch-sensitive screen 14 through the data transmitter region 84 and into the output detector 68. It is expected that this data would be in the form of visual signals such as pixels or other portions of the data transmitter region 84 lighting or darkening (or changing color) which will be recognized by the accessory 60 as being digital data. On the contrary, data passing from the accessory 60 to the touch-sensitive screen 14 would utilize the touch-sensitive functionality of the screen 14. The transmitter face 78 (which is aligned to the data receiver region 82) would be designed to generate tactile or electrical impulses in a pre-assigned location which will be identified as representing digital data for the purpose of creating an input data stream from the accessory 60 to the computing device. FIG. 8 and FIG. 9 depict a sequence of steps in these input and output communications processes.

FIG. 8 depicts a preferred embodiment of the user input communications process of the present invention. When the user creates an input 102 at the input/output device 70, it will be in the form of digital data 104. The interface module 62 will convert the digital data into tactile signals generated by the input transmitter 66 for receipt at the data receiver region 82 on the input screen assembly 42. These tactile signals 106 could be generated by a form of a mechanical stylus or other mechanical pointer which is sophisticated enough to provide sufficient bandwidth for the wide variety of input or input/output devices discussed previously. Preferably, however, it would be expected that these signals 106 would not actually be tactile but would rather be electrical representations of a finger touch that would be indistinguishable to the input screen assembly 42. In any event, the data receiver region 82 of the input screen assembly 42 would accept those signals 106 and convert them to digital data 108 based on their content and location on the data receiver region 82. Then the computing device 20, or specialized software running on, or in cooperation with the computing device 20 would convert the digital data 108 into the user input 110 to the software program being controlled by the input/output device 70. Finally turning to FIG. 9, we can examine how the output process works.

FIG. 9 depicts a preferred embodiment of the computing device output communications process of the present invention. Reading from right to left, the computing device 20 generates the software program output 114 which is converted into digital data 116. That digital data 116 is displayed in the data transmitter region 84 of the display screen assembly 44. What is generated are a plurality of visual signals 118 that are recognized by the output detector 68 by their composition and their location to be converted into digital data 120 by the interface module 62. This interface module 62 then passes the digital data 120 as program output 22 such as data for printing on a printer or audio data for output at speakers or virtually any other outgoing data that would typically be handled by a conventional, peripheral or input/output device connected in a conventional way to the computing device.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A device for providing input to, or accepting output from a programmable computer, said programmable computer comprising a display monitor for displaying visible images thereon and detecting user touches thereto, the device comprising:
a housing;
an attachment element associated with said housing for attaching said housing to said display monitor touch-sensitive surface; and
an input/output element defined by an input element portion and an output element portion physically associated with said housing, said input element portion cooperating with said touch-sensitive display monitor surface to simulate user touches thereto, and said output element portion cooperating with said visible image display portion to convert said displayed visible images into computer-readable data.

2. The device of claim 1, wherein:
said programmable computer and said device cooperate such that said programmable computer displays visible images for interpretation by said device within a data transmitter region on said display monitor; and
whereby said input element is located to view said visible images in said data transmitter region when said housing is attached to said display monitor.

3. The device of claim 2, wherein:
said programmable computer and said device cooperate such that said attachment device creates said simulated user touches within a data receiver region defined by said programmable computer on said monitor when said device is attached to said touch-sensitive surface; and
said programmable computer interprets user touches within said data receiver region as being computer-readable data.

4. The device of claim 3, further comprising an input device operatively connected to said input/output element, whereby user inputs to said input device are converted into said simulated user touches to said touch-sensitive surface.

5. The device of claim 4, further comprising an output device operatively connected to said input/output element, whereby outputs generated by said programmable computer and converted into said visible images in said data transmitter region are transferred from said device to said output device, whereafter said programmable computer outputs are output.

6. The device of claim 5, wherein said attachment element comprises a suction cup extending from said housing.

7. The device of claim 6, wherein said input transmitter and said output detector are located within said suction cup.

8. The device of claim 7, further comprising a mechanical control accessory in communication with said input/output element, said mechanical control accessory generating said simulated user touches and resultant computer-readable data in response to physical movement thereof.

9. A method for providing user input to a programmable computer, said programmable computer comprising a touch-actuatable data display monitor, the method comprising:
attaching an interface module to said touch-actuatable surface of said data display monitor, said interface module configured to create touch actuations to said data display monitor;
providing the user with a control element in communication with said interface module for converting user input to said control element to said interface module for generating said touch actuations.

10. The method of claim 9, wherein said interface module of said attaching step is further configured to receive visible images displayed on data display monitor and convert them into computer-readable data, the method further comprising the step of:
connecting a data output device to said interface module for creating output from said converted computer-readable data.

11. The method of claim 9, wherein said control element of said providing step comprises a mechanical input feature operable by said user through tactile operation to generate said user input to said interface module.

12. The method of claim 10, further comprising attaching a second said data output device to said interface module.

13. The method of claim 9, further comprising a second said interface module to said touch-actuatable surface.

14. A computing system, comprising
a central computer within which a one or more programs comprising computer-executed statements are operable;
a touchscreen display assembly sending data to said central computer in response to touches to the screen of said assembly and displaying visual images responsive to data received from said central computer; and
a touch-interfacing input accessory attachable to said screen for generating said touches and receiving said visual images.

15. The system of claim 14, further comprising a mechanical control accessory in communication with said touch-interfacing input accessory, said mechanical control accessory generating said simulated user touches and resultant computer-readable data in response to physical movement thereof.

16. The system of claim 14, wherein:
said central computer and said accessory cooperate such that said touchscreen display assembly displays visible images for interpretation by said accessory within a data transmitter region on said display assembly; and
said accessory is further defined by an input element located to view said visible images in a data transmitter region defined on said display assembly when said housing is attached to said display assembly.

17. The system of claim 14, wherein:
said central computer and said accessory cooperate such that said accessory creates said generated touches within a data receiver region defined by said central computer on said display assembly when said accessory is attached to said display assembly; and
said central computer interprets touches within said data receiver region as being computer-readable data.

18. The system of claim 14, wherein said accessory further comprises a suction cup extending from a housing.
